(19) United States
(12) Patent Application Publication
(10) Pub. No.: US 2026/0065317 A1
(43) Pub. Date: Mar. 5, 2026

(54) APPARATUS FOR ANALYZING THE ADVERTISING EFFECT OF OUTDOOR ADVERTISING MEDIA AND METHOD FOR PERFORMING THE SAME

(71) Applicant: ADDD Inc., Seoul (KR)

(72) Inventors: Hyun Bin KIM, Seoul (KR); Jung Min LEE, Hwaseong-si (KR); Sang Hyun AHN, Seongnam-si (KR)

(21) Appl. No.: 19/386,176

(22) Filed: Nov. 11, 2025

Related U.S. Application Data
(63) Continuation of application No. 19/082,090, filed on Mar. 17, 2025.

(30) Foreign Application Priority Data
Aug. 9, 2024 (KR) 10-2024-010662

(51) Int. Cl. G06Q 30/0242; G06T 7/11; G06T 7/20; G06T 7/73; G06V 10/764; G06V 20/54; G06V 40/10; G06V 40/20

(52) U.S. Cl. CPC G06Q 30/0246; G06T 7/11; G06T 7/20; G06T 7/73; G06V 10/764; G06V 20/54; G06V 40/103; G06V 40/20; G06T 2207/10016; G06T 2207/30196; G06T 2207/30232; G06T 2207/30236; G06T 2207/30242; G06V 2201/08

(57) ABSTRACT

An apparatus and method for measuring the advertising effectiveness of an advertising medium provide users (e.g., advertisers, advertising agencies, media owners) with advertising analysis data and measurement results in real time. Based on the data provided, the users can implement various advertising strategies to optimize their campaigns. In some examples, the apparatus captures an image or video of an individual, a space, or a vehicle located within a visibility range of the advertising medium using a vision sensor; receives and analyze the captured image or video at a computing device; and transmits the analyzed results, including advertising effectiveness measurement results, to a terminal device or a server. The computing device may analyze information related to the individual, the space, or the vehicle based on the received image or video.

### CROSS-REFERENCE TO RELATED APPLICATION

This U.S. application is a continuation of U.S. application Ser. No. 19/082,090, filed on Mar. 17, 2025, which claims priority to and the benefit of Korean Patent Application No. 10-2024-010662, filed on Aug. 9, 2024, in the Korean Intellectual Property Office (KIPO), the disclosures of all of which are incorporated by reference herein in their entireties.

### FIELD OF THE DISCLOSURE

The present disclosure relates to an apparatus and method for analyzing the effectiveness of advertisements displayed in outdoor advertising media. Specifically, it involves analyzing information such as people, vehicles, and weather conditions around the advertising media and measuring the effectiveness of the advertisements based on the analyzed information.

### BACKGROUND OF THE DISCLOSURE

Indoor and outdoor advertising generally targets a large audience, including pedestrians and individuals inside vehicles. This method of advertising is considered effective because it exposes passersby to advertisements without requiring their active engagement. However, objectively evaluating the effectiveness of outdoor advertisements has proven challenging. Traditionally, the effectiveness of outdoor advertising has been estimated by analyzing pedestrian and vehicular traffic near the advertising medium, based on conventional assumptions rather than precise measurements.

In contrast, online advertisements provide greater targeting capabilities, allowing advertisements to be directed at specific viewers (e.g., computer users) based on the content of the advertisement. Additionally, online advertising effectiveness is relatively easier to measure through metrics such as click-through rates and user engagement. However, outdoor advertising faces inherent difficulties in accurately determining how much attention pedestrians or vehicle occupants have paid to an advertisement, as well as in measuring the advertisement's impact on its audience.

Therefore, there is a need for a method that can accurately measure the effectiveness of outdoor advertising media based on objective data, rather than relying on assumptions or traditional estimations.

### SUMMARY OF THE DISCLOSURE

The present disclosure addresses the challenges associated with measuring the effectiveness of outdoor advertising media by providing an apparatus and method for analyzing and quantifying advertising impact. The analysis utilizes data such as the frequency of individual views, the duration of viewing, and attention-related metrics.

The disclosure provides an apparatus configured to capture an image or video of an individual, a space, or a vehicle located within a visibility range of the advertising medium using a vision sensor; receive and analyze the captured image or video at a computing device; and transmit the analyzed results, including advertising effectiveness measurement results, to a terminal device or a server. The computing device may analyze information related to the individual, the space, or the vehicle based on the received image or video.

The disclosure employs vision sensors, including cameras, to collect information about pedestrians and other passersby. This information is analyzed to determine whether individuals within the visibility range of the advertising media recognize and pay attention to the advertisements. The results of this analysis are quantified to generate actionable data on advertising effectiveness, offering valuable insights to users.

The disclosure leverages artificial intelligence (AI) technology to enhance both the accuracy and efficiency of advertising effectiveness measurements, thereby providing a robust solution for evaluating the impact of outdoor advertisements. It establishes a foundation for developing advanced advertising solutions and service platforms that foster mutual benefits among advertisers, media owners, and other stakeholders in the advertising industry.

The disclosure provides a method for improving data accuracy and completeness by enabling the sharing of collected data among multiple advertising media sensors. Through this approach, the system can predict the flow of passersby and prepare targeted advertisements in advance for display at scheduled times, thereby enhancing the effectiveness of advertising campaigns.

The disclosure facilitates the objective analysis of the effectiveness of advertisements displayed via advertising media. Users including advertisers, advertising agencies, media owners, and media buying agencies (collectively referred to as “users”) can access advertising analysis data and measurement results in real time. Based on the data provided, the users can formulate and implement various advertising strategies to optimize their campaigns.

Beyond analyzing the effectiveness of outdoor advertisements, the disclosure can be applied to visitor analysis in offline spaces such as exhibitions, event venues, and pop-up stores. By utilizing cameras and edge computing, the disclosure enables the analysis of attributes such as gender, age, dwell time, movement paths, and gaze direction of visitors in venues including pop-up stores, exhibition halls, large retail stores, and various shops. This functionality facilitates the measurement of offline marketing performance, which has traditionally been difficult to evaluate.

It is noted that the objectives and advantages of the disclosure are not limited to those explicitly described above. Other objectives and advantages will become apparent to those skilled in the art based on the detailed description of the specification and accompanying drawings.

It is also noted that the solutions for solving the problems described herein are not intended to be limiting. Additional solutions not explicitly disclosed will be apparent to those skilled in

### BRIEF DESCRIPTION OF THE DRAWINGS

The accompanying drawings illustrate exemplary embodiments of the present invention and, together with the detailed description, serve to explain the principles of the disclosure. It is understood that the embodiments illustrated herein are provided for example purposes only and are not intended to limit the scope of the disclosure.

FIG. 1 illustrates a system configuration for analyzing and measuring advertising effectiveness according to an embodiment of the disclosure.

FIG. 2 depicts a method for analyzing and measuring advertising effectiveness according to an embodiment of the disclosure.

FIG. 3 is a flowchart illustrating a method of analyzing and measuring advertising effectiveness using a computing device according to an embodiment.

FIG. 4 is a flowchart illustrating a method of analyzing and measuring advertising effectiveness on a server according to an embodiment.

FIG. 5 illustrates advertising analysis data and advertising effectiveness measurement results displayed on a terminal according to an embodiment.

FIG. 6 is a block diagram illustrating another embodiment of a method for analyzing advertising effectiveness.

FIGS. 7A and 7B depict examples of generating an object's boundary box and identifying key body points of a person according to an embodiment.

FIG. 8 is a flowchart illustrating another embodiment of a method for analyzing advertising effectiveness.

FIG. 9 illustrates a configuration of an advertising effectiveness analysis apparatus according to an embodiment.

### DETAILED DESCRIPTION

The objectives, features, and embodiments of the disclosure will be described in detail with reference to the accompanying drawings. However, descriptions of well-known components, functions, or processes related to the disclosure and technical details that are well-known to those skilled in the art may be omitted where their inclusion could obscure the essence of the disclosure.

The embodiments described herein are provided to illustrate the inventive concept and to enable those skilled in the art to implement the disclosure. Accordingly, the disclosure is not limited to these embodiments, and the scope of the disclosure encompasses modifications and variations that do not depart from its spirit or essential characteristics.

The terms used in this specification have been carefully selected to reflect the functions of the disclosure and align with terminology widely accepted in the relevant technical field. However, the meanings of these terms may vary depending on the intent of those skilled in the art, judicial interpretations, or advances in technology. Specific definitions for certain terms may be provided in this specification. Unless explicitly defined otherwise, the terms should be interpreted based on their contextual meaning within the entire specification rather than any isolated or literal interpretation.

Where numerical designations (e.g., “first,” “second,” “third”) are used to describe components or steps, these are intended as identifiers for differentiation and do not imply any particular order or priority unless explicitly stated.

The symbol “/” in this specification should be interpreted inclusively, covering one or more combinations of the listed items. For instance, “and/or” encompasses one or more of the specified items, and “transmitting A/B” means transmitting A only, B only, or both A and B.

Singular terms (e.g., “a”, “an”) in this specification should be interpreted as including their plural forms unless the context clearly indicates otherwise.

The terms “include” and “have/has,” as used in this specification, indicate the presence of features, elements, or steps but do not preclude the inclusion of additional features, elements, or steps.

The drawings accompanying this specification are provided to aid in understanding the disclosure. Shapes, proportions, and configurations depicted in the drawings may be exaggerated or simplified for clarity and should not be construed as limiting the disclosure to the depicted structures.

In some embodiments, the sequence of processes may be altered. For example, processes described sequentially may be performed simultaneously or in a different order depending on the implementation.

When a component is described as being “connected to” or “coupled with” another component, this may refer to a direct or indirect connection. If “directly connected” or “directly coupled” is specified, there are no intervening components. Similarly, relational terms such as “between,” “directly between,” “adjacent to,” or “directly adjacent to” should be interpreted accordingly. For example, when components are described as being “electrically connected,” this includes both direct electrical connections and indirect connections through intermediary components.

The methods described in the embodiments of the disclosure may be implemented as computer-executable instructions stored on a computer-readable medium. Such computer-readable media may include program instructions, software, algorithms, data files, and data structures, either individually or in combination. Examples of computer-readable media include, but are not limited to, magnetic media (e.g., hard disks, floppy disks, and magnetic tapes), optical media (e.g., CD-ROMs, DVDs, and Blu-ray discs), magneto-optical media (floptical disks), memory devices (read-only memory (ROM), random access memory (RAM), flash memory, and other types of memory). The program instructions stored on the computer-readable medium may include machine code generated by a compiler or high-level code that can be executed by a computer using an interpreter.

Such instructions may be executed by a processor within a general-purpose computer, a special-purpose computer, or other programmable data processing equipment to perform the functions described in the flowcharts included in the accompanying drawings. The instructions may also be stored in a computer-readable memory to produce a manufactured item containing the instructions for implementing the functionality described in the flowcharts. Furthermore, these computer program instructions may direct a series of operations to be performed by a computer, thereby creating a process that executes the described functions.

The hardware components described in the embodiments may include one or more software modules configured to perform the operations disclosed herein. Conversely, software implementations may also be achieved using hardware components.

The term “unit” as used in the disclosure may refer to both software and hardware components. Examples include Field Programmable Gate Arrays (FPGAs), Application-Specific Integrated Circuits (ASICs), stored programs, or configurations that operate one or more processors. The term is not restricted to any specific implementation method.

In various embodiments, the term “unit” may encompass a broad range of components, including but not limited to: software components (e.g., object-oriented components, classes, tasks, processes, functions, attributes, procedures, subroutines, program code segments, drivers, firmware, and microcode), hardware components (e.g., circuits, chips, or other hardware-specific implementations), data structures (e.g., databases, tables, arrays, variables, and other forms of data organization). The functionalities provided by the units or components may be consolidated into fewer units or distributed among additional units as necessary. These units may be implemented on various devices, including secure multimedia cards (SMCs) or platforms with one or more CPUs. In certain embodiments, a unit may comprise one or more processors configured to execute program instructions and perform the operations described herein.

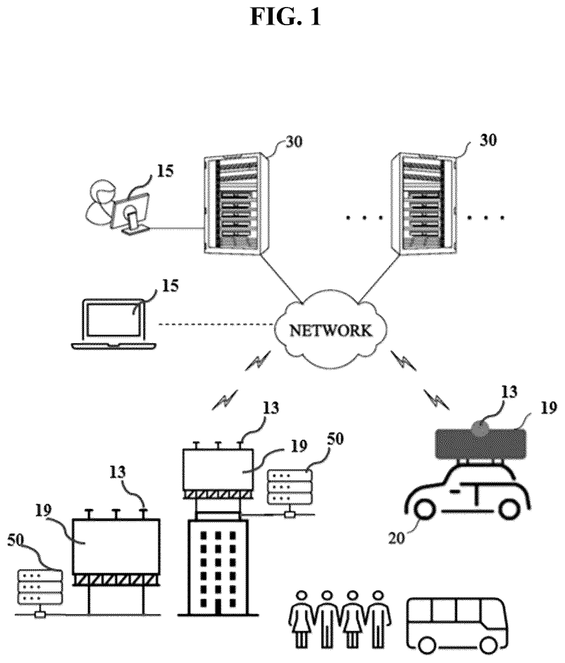

FIG. 1 illustrates the configuration of a system for analyzing and measuring advertising effectiveness according to an embodiment of the disclosure. The system comprises an advertising medium for displaying advertisements, sensors for collecting information around the advertising medium, a computing device for analyzing the collected information (such as images, videos, or weather data), a server for processing and storing the analyzed data, and a terminal device for presenting the analyzed data and advertising effectiveness results to users.

The advertising medium is a device designed to display advertisements in either print or digital form to individuals such as pedestrians or occupants of vehicles. It may display static print advertisements or dynamically show images, videos, news, or other information in real time. The operation of the advertising medium can be based on preset schedules, random selection, or results derived from advertising effectiveness analysis. Examples of such media include various types of display-based devices, such as digital signage, LED displays, LCD displays, OLED displays, or other electronic display technologies. Additionally, the advertising medium may incorporate auxiliary electronic devices or equipment to support its functionality.

The advertising medium can be installed in diverse locations, including indoors, outdoors, on vehicles, building rooftops, exterior walls, or standalone roadside structures like billboards. In certain embodiments, the advertising medium may be mounted on the exterior or interior of mobile vehicles, such as advertising trucks, cars, buses, motorcycles, bicycles, or other means of transportation. Its size can vary based on the installation location and intended purpose. When installed on vehicles, the advertising medium can display advertisements transmitted from the server. These advertisements may adapt dynamically based on the vehicle's driving patterns and the movement patterns of pedestrians in the vicinity, enabling highly targeted and adaptive advertising.

The system also includes sensors that collect information surrounding the advertising medium. These sensors may include vision sensors, such as cameras, CCTV, or LiDAR devices, that capture images or videos of the surrounding environment. Additionally, environmental sensors may measure weather-related data, including temperature, humidity, fine dust levels, precipitation, snowfall, sunrise and sunset times, wind direction, and wind speed. Vision sensors may include commercially available devices like webcams, cameras, and CCTV systems. For on-device data collection, compact cameras may be integrated directly into the advertising medium. Other sensors, such as GPS modules, microphones, and speakers, may be included to enhance data collection and interaction capabilities.

By integrating these components, the system collects and analyzes comprehensive data to evaluate the effectiveness of advertisements displayed on the advertising medium.

The computing device (50) is responsible for analyzing the information collected by the sensor (13) and converting it into actionable advertising effectiveness data. It processes the collected information independently or combines it with other datasets to generate meaningful insights for users. These insights are then transmitted to a terminal device (15) or server (30). For instance, the computing device can analyze images or video captured by a camera to extract data related to people and vehicles. It can be installed internally or externally relative to the advertising medium or located remotely, communicating with the advertising medium via wired or wireless connections. The computing device is capable of analyzing metrics such as the number of individuals facing the advertising medium, the number paying attention to the advertisement, and the duration of their attention.

The server (30) receives information from the sensor (13), analyzes it, and formats it into data that is useful for users. The server may enhance the collected data by combining it with other datasets to increase its value. It then transmits the analyzed data and advertising effectiveness results to a terminal device (15) or another server. Depending on system requirements, the setup may involve a single server or multiple servers. The server can take various forms, including a general network server, a personal computer, a high-performance computing system, or a cloud-based server. Furthermore, the server may distribute the advertising effectiveness data to other servers or devices for additional processing or dissemination.

Both the computing device (50) and server (30) include programs required for data analysis and advertising effectiveness measurement. These devices are capable of analyzing data points such as the posture of individuals, the walking direction of pedestrians (e.g., whether they are approaching or moving away from the advertising medium), the number of people facing the advertising medium, the number of individuals recognizing and paying attention to the advertisement, and the duration of their attention.

The terminal device (15) is used to display the analyzed data and advertising effectiveness results to users, which may include advertisers, advertising agencies, media owners, media buying agencies, and other stakeholders in the advertising industry. The terminal device may be a personal computer, tablet, laptop, smartphone, or similar device. It provides a user-friendly interface, accessible through a web-based or app-based platform, enabling users to easily view and interpret advertising analysis data and effectiveness results.

Additionally, the system supports sharing information collected from sensors installed on multiple adjacent advertising media to improve data accuracy and completeness. By sharing data such as actual audience data, potential audience data, vehicle data, pedestrian movement patterns, demographic information (e.g., gender and age), advertisement display information, and environmental conditions, the system achieves a comprehensive understanding of the audience, surroundings, and pedestrian flow near the advertising media. This capability allows the system to predict pedestrian movement trends and tailor targeted advertisements to specific audiences based on their gender, age, and context. These advertisements are displayed at optimal times to maximize advertising effectiveness.

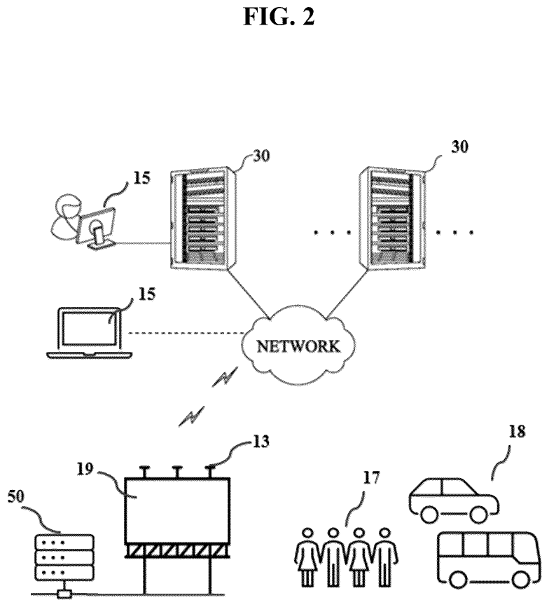

FIG. 2 illustrates a method for analyzing and measuring advertising effectiveness in accordance with an embodiment of the disclosure. As described with reference to FIG. 1, the advertising medium (19) can be installed in various locations, including indoors or outdoors, on mobile vehicles such as advertising trucks, on building rooftops or exterior walls, or as standalone roadside installations. FIG. 2 highlights the core components of the system, independent of the specific installation location of the advertising medium.

The sensor (13) comprises vision sensors, such as cameras, that capture images of the area surrounding the advertising medium, as well as environmental sensors that gather contextual data, including weather conditions at the medium's location. The sensor may also incorporate GPS modules, microphones, and speakers to collect additional information.

The vision sensor captures images of individuals (17) and vehicles (18) within the visibility range of the advertising medium. To accommodate different monitoring requirements, the performance of the vision sensor can be adjusted based on the size of the monitored area and the number of people visible in the camera's field of view. Parameters such as resolution, field of view (FOV), focal length, and infrared (IR) conversion capabilities can be optimized to ensure effective detection of individuals over long distances and under low-light or nighttime conditions.

For improved functionality, the visibility range can be divided into two or more groups, allowing the vision sensor and computing device to be configured according to the specific size and nature of the monitored area. Examples of such configurations include the following: In small spaces, such as elevators or menu order displays, where the distance from the advertising medium ranges from approximately 0.5 meters to 10 meters and up to 15 individuals are exposed to the advertisement simultaneously, the system can rely on a compact computing board equipped with only a CPU, eliminating the need for a GPU. Narrow FOV cameras, such as webcams or small cameras, can effectively capture images in such environments.

In medium spaces, such as offices, restaurants, or retail stores with digital signage, where the distance from the advertising medium ranges from approximately 1 meter to 40 meters and up to 50 individuals are exposed simultaneously, a small PC or a computing board equipped with a GPU or NPU can perform the analysis. Cameras with a resolution of 1 megapixel or higher, such as webcams or CCTV cameras, are suitable for capturing images in these environments.

In large spaces, such as building exterior billboards, roadside advertising media, or standalone billboards, where the distance from the advertising medium ranges from approximately 5 meters to 130 meters and up to 150 individuals are exposed simultaneously, high-performance computing boards equipped with GPUs or NPUs are required for effective analysis. Cameras with a resolution of 2 megapixels or higher, such as high-resolution cameras or advanced CCTV cameras, can capture detailed images suitable for analysis in these environments.

The sensor (13) can be installed on various parts of the advertising medium, including its exterior, top, sides, or bottom. Alternatively, the sensor can be built into the advertising medium or installed separately at a remote location to suit specific implementation requirements. This flexible installation capability ensures compatibility with a wide range of advertising setups and use cases.

The advertising medium (19) refers to a device that displays advertisements in print or digital form to individuals. It can continuously display static print advertisements or dynamically show various images, videos, and information in real time based on preset schedules, random selection, or advertising effectiveness analysis results. In embodiments where the advertising medium displays multiple advertisements or adjusts content based on analysis results, it may take the form of a digital display, such as an LCD/LED screen or digital signage.

The computing device (50) periodically or in real time analyzes the information collected from the sensor (13) and converts it into actionable advertising effectiveness data. It includes one or more programs designed to combine or transform the collected data with other datasets to analyze advertising effectiveness metrics. For instance, the computing device may analyze images or videos captured by cameras to extract data related to individuals and vehicles. These programs may be embedded within the computing device, server, or a cloud-based system.

Specifically, the programs include modules such as a person state analysis program to assess the exposure, viewing, and attention states of individuals; a person count aggregation program to calculate the number of exposed, viewing, and attentive individuals; a person distribution analysis program to determine the gender and age distribution of the audience; and a person behavior analysis program to evaluate movement paths, dwell times, and inflow/outflow trends of individuals. Additional modules include a space analysis program to analyze population density and dwell population in specific zones, a vehicle analysis program to assess the number, type, and speed of vehicles, and a potential audience aggregation program to estimate the number of individuals inside vehicles within the visibility range of the advertising medium.

The computing device assesses whether individuals within the visibility range are in an exposure state (visible to the advertising medium), a viewing state (actively looking at the advertisement), or an attention state (sustained viewing for a predetermined period, such as more than one second). Based on this analysis, the system calculates the number of exposed individuals, viewers, and attentive individuals. It further generates gender and age demographic data for each group and analyzes movement patterns, inflow/outflow trends, and population density within the monitored area.

For vehicles within the visibility range of the advertising medium, the system classifies them by type (e.g., passenger cars, buses, trucks, motorcycles) and counts the number of each type. It also measures vehicle speeds and generates data accordingly. To estimate potential audience size, the system applies weighting factors to account for the average number of passengers in each type of vehicle (e.g., 1.5 people per passenger car, 10 people per bus, 1 person per truck or motorcycle). These weighting factors may be adjusted based on the advertising medium's location, weather conditions, or specific user strategies.

By applying artificial intelligence (AI) technologies trained on extensive image datasets, the system detects and tracks pedestrians, classifies demographic data such as gender and age, and analyzes attention status. The use of deep learning and AI models enhances the precision and efficiency of pedestrian detection, demographic classification, and attention analysis, providing a robust measurement of advertising effectiveness.

The analyzed data or advertising effectiveness results generated by the computing device are transmitted to the terminal device (15) or server (30) via a network. This data may be formatted into a user-friendly format for periodic or real-time transmission. Additionally, the computing device includes a data combination program that integrates advertisement display information from the advertising medium with environmental data from the sensors to generate metadata. The metadata includes metrics such as the number of exposed individuals, viewers, and attentive individuals, gender and age distributions, viewership and attention rates, most exposed days of the week, peak exposure times, average exposure frequency, viewing times, and dwell times.

The computing device is also capable of generating time-series metadata by aligning multiple datasets using time intervals, ensuring consistency and enhancing integrated analysis. Time-series metadata can include advertising data combined with environmental variables, such as temperature, humidity, fine dust levels, precipitation, snowfall, sunrise/sunset times, wind direction, wind speed, and GPS-based location data.

In the case of mobile advertising media, such as those mounted on vehicles, the system can update real-time location information using GPS sensors, integrate speed and environmental data, and combine this information with advertising analysis data. By quantifying performance metrics such as audience size, demographics, and environmental context, the system provides advertisers with detailed and accurate assessments of advertising effectiveness based on various criteria, including time of day, weather, and demographic distribution.

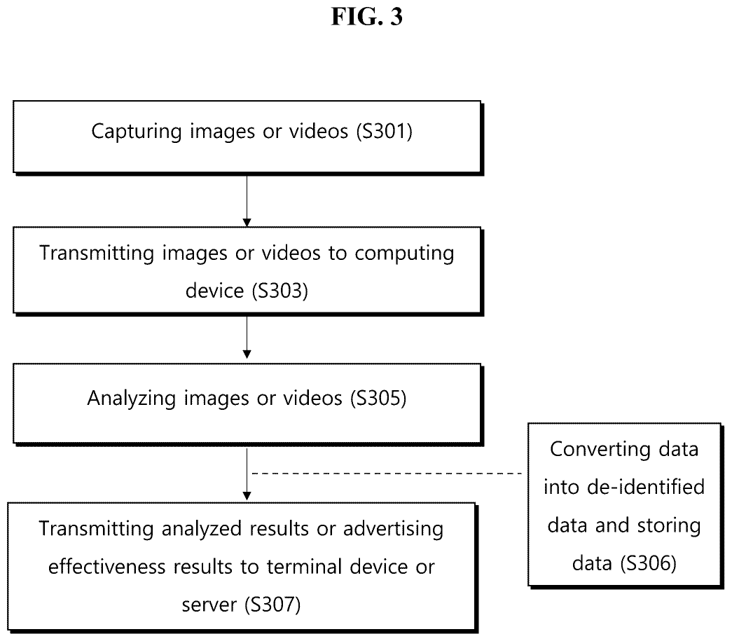

FIG. 3 illustrates a flowchart of a method for analyzing and measuring advertising effectiveness using a computing device according to an embodiment of the disclosure. In Step S301, the vision sensor captures images or videos of individuals and vehicles within the visibility range of the advertising medium, which are capable of viewing the displayed advertisement. These captured images or videos are then transmitted to the computing device either periodically or in real time (Step S303). The transmission between the vision sensor and the computing device can be achieved using various communication methods, including wired or wireless connections.

In Step S305, the computing device analyzes the received images or videos. This analysis involves utilizing one or more programs to extract data related to individuals and vehicles, which are essential for measuring the advertisement's effectiveness. The analysis process includes detecting pedestrians and vehicles in the captured images or videos, tracking their movement, analyzing postures, and identifying gender and age. These analyses can be performed periodically or in real time, with the programs running on the computing device, server, or a cloud-based platform. The programs embedded in the computing device perform several analytical tasks, including determining the exposure, viewing, and attention status of individuals, aggregating the counts of exposed, viewing, and attentive individuals, and analyzing gender and age distribution. Additionally, the programs track movement paths, dwell times, and inflow/outflow patterns of individuals, assess population density and dwell population within the monitored area, and analyze vehicle data such as type, count, and speed. The programs also estimate potential audience members by counting individuals inside vehicles within the visibility range.

In Step S306, the computing device converts the analyzed data into de-identified data to ensure privacy protection. The original images or videos are not stored; instead, only anonymized data is retained. During the de-identification process, each individual and vehicle in the captured data is assigned a random ID, with attributes such as gender, age, dwell time, and movement paths recorded. This ensures that the data cannot be used to specifically identify individuals or vehicles while preserving its utility for analysis.

The analyzed results or advertising effectiveness results are then transmitted to a terminal device or a server (Step S307). These results may include individual data (e.g., status, count, distribution, and behavior), spatial analysis data, vehicle analysis data, and actual/potential audience data. The transmission may occur periodically (e.g., every second, minute, hour, or day) or in real time, depending on the system configuration.

The transmitted data can include various categories of information, such as actual audience data (e.g., IDs of individuals and vehicles, vehicle types, exposure/viewing/attention times, gender, age, dwell times, movement direction, speed, and timestamps) and potential audience data (e.g., estimates of individuals inside vehicles within the visibility range). It may also include advertisement display information (e.g., advertisement ID, type, broadcast start and end times, video length, and timestamps) and environmental information about the advertising medium (e.g., medium ID, location, latitude, longitude, movement speed, weather conditions, and timestamps).

The computing device transmits metadata, advertising medium performance data, advertising effectiveness results, and statistical insights to the terminal device or server periodically or in real time. Users can access this data via the terminal device, enabling them to make informed decisions and optimize their advertising strategies based on the analytics provided. The data is delivered in a user-friendly format, allowing stakeholders to interpret the results efficiently and implement adjustments to improve campaign performance.

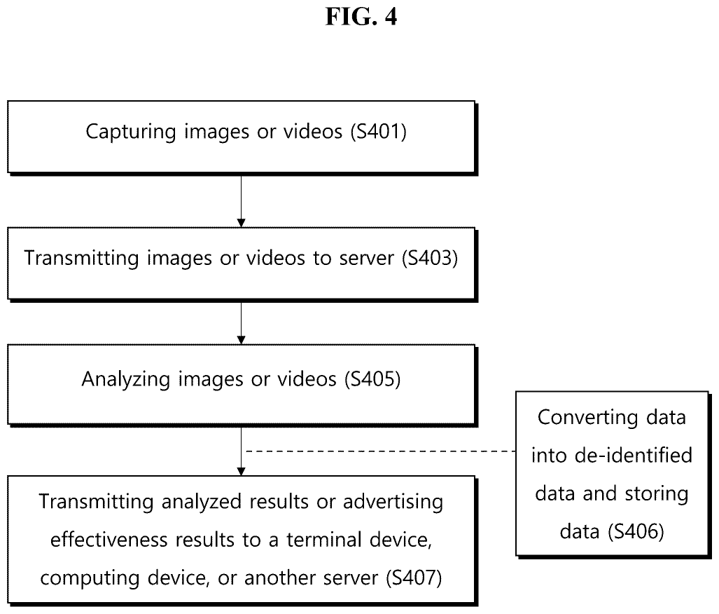

FIG. 4 illustrates a flowchart of a method for analyzing and measuring advertising effectiveness using a server, according to an embodiment of the disclosure. While a computing device, as explained in FIG. 3, can analyze collected information and measure advertising effectiveness, the server may perform these functions either in parallel with the computing device or independently.

In Step S401, the vision sensor captures images or video of individuals and vehicles within the visibility range of the advertising medium. These captured images or videos are transmitted to the server either periodically or in real time (Step S403). Upon receiving the transmitted data, the server processes and analyzes the images or videos (Step S405).

The server employs one or more programs to analyze data related to individuals and vehicles, extracting information necessary for measuring advertising effectiveness. These programs, which can be embedded within the server or hosted on a cloud platform, detect pedestrians and vehicles, track objects, analyze postures, and determine demographic information such as gender and age.

Following the analysis, the server converts the processed data into de-identified data and stores it in a storage device, another server, or a cloud platform (Step S406). To ensure privacy protection, the original images or videos are not retained; instead, only anonymized data is stored. During the de-identification process, random IDs are assigned to individuals and vehicles, with attributes such as gender, age, dwell time, and movement paths recorded. This process ensures that specific individuals or vehicles cannot be identified from the stored data.

In Step S407, the analyzed results or advertising effectiveness results are transmitted to a terminal device, computing device, or another server. The server combines or transforms the data into a user-friendly format before transmission. The transmitted data may include audience-related information, such as exposure counts, viewing counts, and attention counts, as well as spatial analysis data, including population density and dwell time. Additionally, vehicle-related data such as vehicle count, type, and speed may also be included.

When handling multiple advertising media, large volumes of data, or providing advertising effectiveness measurement platform services to users, the server offers significant advantages over relying solely on a computing device. The server is capable of efficiently processing and managing large datasets and delivering real-time or periodic updates to users through terminal devices or other servers.

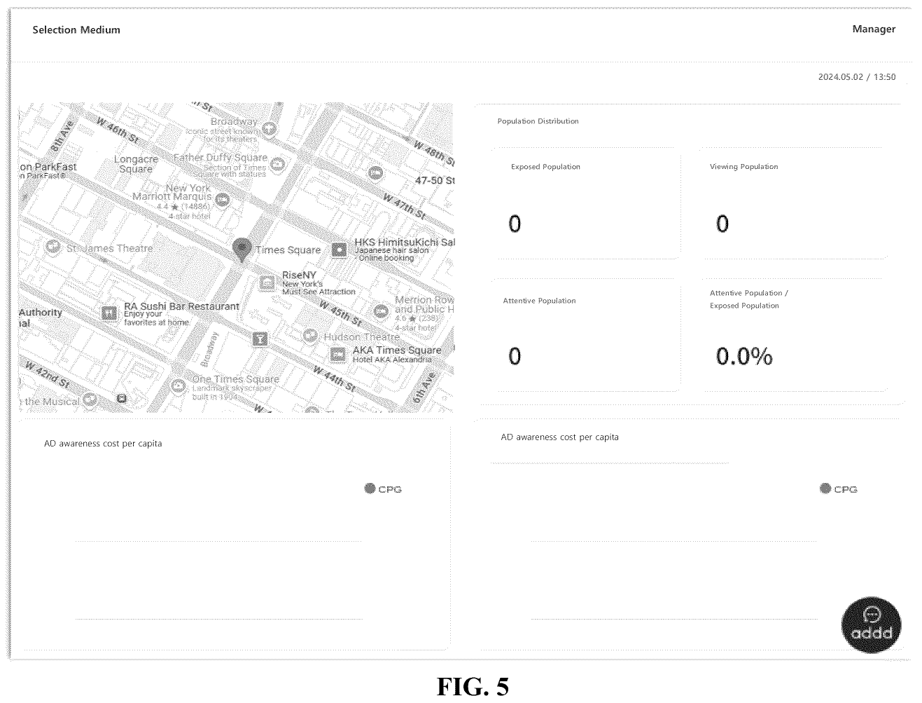

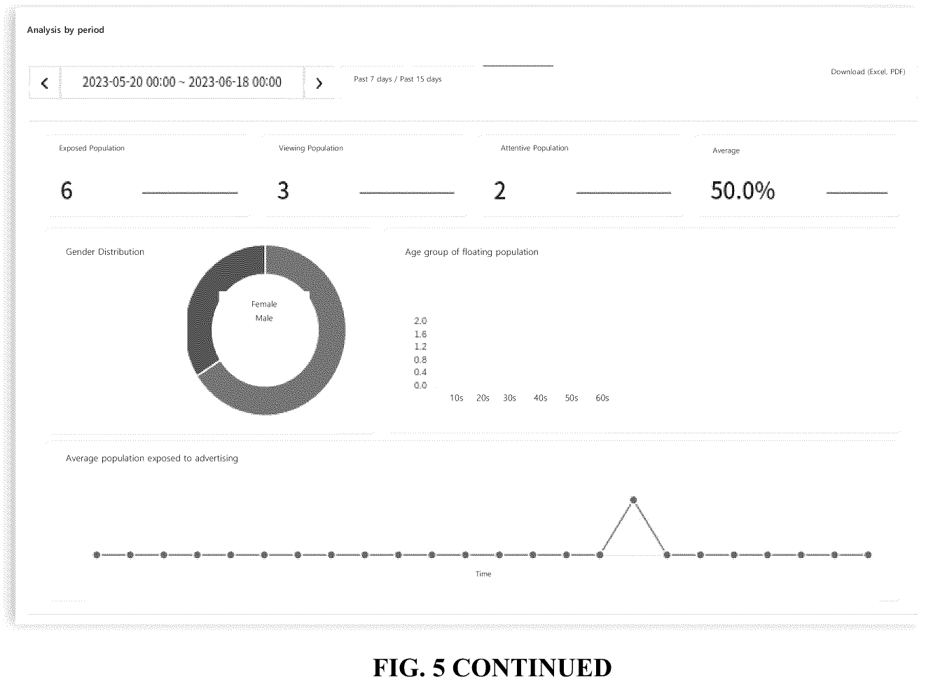

By utilizing the server for analysis, the system ensures scalability, data consistency, and high performance, particularly for large-scale advertising campaigns across multiple locations. Furthermore, the server seamlessly integrates with the computing device and cloud infrastructure, providing a comprehensive solution for advertising effectiveness analysis. FIG. 5 illustrates a terminal device displaying advertising effectiveness analysis data and measurement results according to an embodiment of the disclosure. The data analyzed by the computing device or server, along with the advertising effectiveness results, is transmitted to the terminal device and updated continuously. Users can view this data in real time through the terminal device.

The terminal device provides users with access to a wide range of data and information, including the location of the advertising medium, the location of advertising effectiveness analysis equipment, exposed population, viewing population, attentive population, and floating population. Additional data includes demographic metrics such as gender distribution and age distribution, performance indicators like viewership rate and attention rate, and temporal metrics such as the most exposed day of the week, peak exposure times, average display frequency, average viewing time, and average dwell time. Metadata, advertising medium performance data, advertising effectiveness results, and other statistical figures and graphs are also made available. Users can customize the terminal device to display only the specific data of interest to them.

To enhance usability, the terminal device visualizes the analyzed data and information using charts, graphs, tables, and other graphical representations. These visualizations improve readability and help users better comprehend the data. For added flexibility, users can specify a date or time period to review, selecting a specific range to view corresponding advertising analysis data and effectiveness results.

The terminal device also supports downloading reports in various formats, including Word, PDF, or Excel, enabling users to perform further analysis or maintain records for future reference. By combining robust data analysis with intuitive data visualization, the disclosure provides users with comprehensive insights into the effectiveness of advertisements displayed on the advertising medium. The ability to present data in an easily understandable format and generate tailored reports significantly enhances the system's usability and practical value.

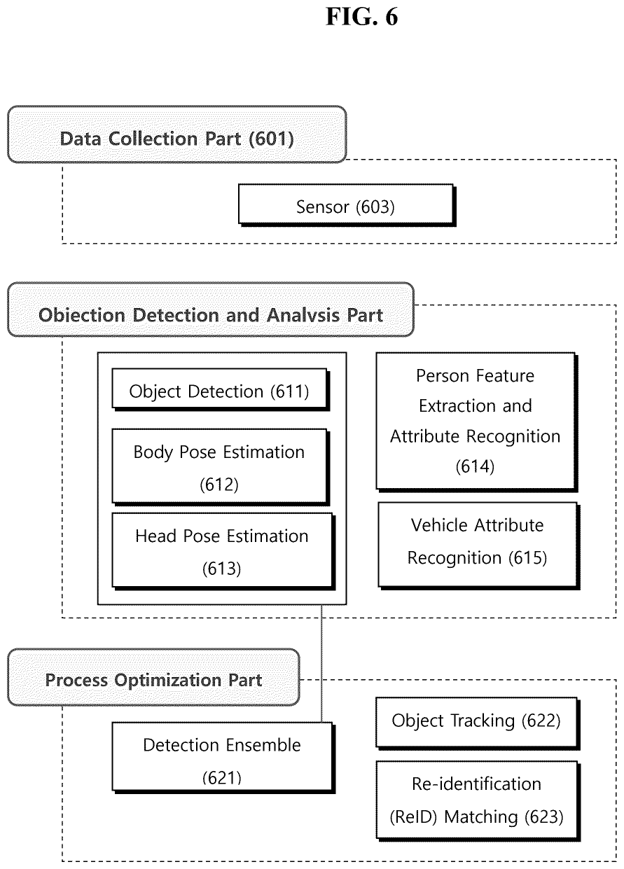

FIG. 6 illustrates a block diagram of another embodiment for analyzing advertising effectiveness. In this embodiment, an advertising effectiveness measurement program analyzes images or videos captured by a vision sensor in real time to generate advertising effectiveness data. The program can be deployed on a computing device, server, or cloud platform. The method consists of three main parts: data collection, object detection and analysis, and process optimization. Each part comprises specific steps that can be executed sequentially or in parallel.

In the data collection part (601), the vision sensor (603) captures real-time images or videos of individuals and vehicles within the visibility range of the advertising medium. This data serves as the foundation for subsequent analysis.

In the object detection and analysis part (610), the system applies computer vision technologies to detect, analyze, and categorize individuals and vehicles in the captured images. Object detection (611) identifies individuals and vehicles, outputting bounding box coordinates for each detected object. Body pose estimation (612) identifies the key body points of individuals (e.g., eyes, nose, shoulders, hips, knees, feet), while head pose estimation (613) determines head orientation and gaze direction. The system further applies person feature extraction and attribute recognition (614) to analyze individual characteristics such as gender and age. For vehicles, vehicle attribute recognition (615) determines type (e.g., passenger cars, buses, trucks, motorcycles) as well as speed and movement direction.

The initial detection process generates bounding boxes for individuals and vehicles. However, inaccuracies or missed detections can occur if relying solely on object detection or body pose estimation. To address this, the system employs a detection ensemble (621) technique, combining results from object detection and body pose estimation by intersecting bounding boxes. This refinement improves detection accuracy. Head pose estimation may also be integrated into the ensemble technique to further optimize bounding box precision.

After optimizing bounding boxes, the system analyzes detected individuals and vehicles in greater detail. Person feature extraction determines demographic attributes (e.g., gender, age, gaze direction), while vehicle attribute recognition classifies vehicle types and movement characteristics.

In the process optimization part (620), the system enhances the speed and accuracy of analysis using advanced techniques such as detection ensemble (621), object tracking (622), re-identification (ReID) matching (623), and prediction accumulation.

Object tracking (622) addresses the issue of individuals or vehicles appearing in different positions across consecutive video frames. By assigning a consistent ID to each detected object, the system ensures that the same individual or vehicle is recognized across frames. This enables the system to track attributes (e.g., gender, age) and behaviors (e.g., viewing, attention, movement direction) over time.

ReID matching (623) further improves tracking accuracy by comparing bounding boxes of detected objects across frames to determine if they belong to the same object. This process ensures seamless tracking, even if an object moves or changes position.

Prediction accumulation refines the tracking process by aggregating data for each object ID. For example, if an individual with a specific ID is tracked over multiple frames, and their gaze direction is within the viewing angle for most frames, the system concludes that they were in a viewing state for that duration. Similar logic can be applied to classify gender or age using majority-vote rules across frames.

By applying these processes, the system performs real-time advertising effectiveness measurements. It identifies whether individuals are exposed to an advertisement, actively viewing it, or paying attention to it for a sustained period. The system also collects demographic data, tracks movement patterns, and categorizes vehicles, generating comprehensive actual and potential audience data.

The real-time analysis provides advertisers with actionable insights, allowing them to optimize their advertising strategies based on the effectiveness of their campaigns. The combination of advanced detection, tracking, and analysis techniques ensures precise and scalable measurement of advertising impact across various environments.

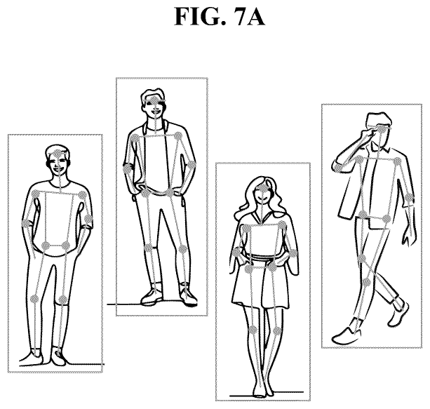

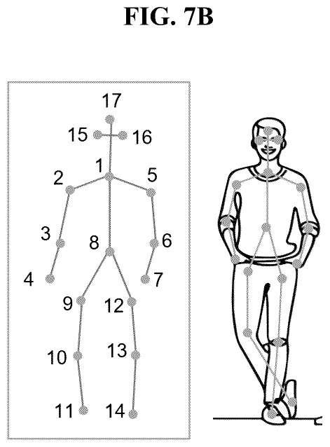

FIGS. 7A and 7B illustrate embodiments in which object detection technology generates bounding box coordinates for detected objects, such as individuals and vehicles, using a deep learning model. As shown in FIG. 7A, the detected objects are enclosed within rectangular boundary boxes to delineate their outlines.

In addition to bounding boxes, body pose estimation technology outputs the coordinates of key body points on a person's body. FIG. 7B illustrates an example where 17 key points are identified, including the eyes, nose, ears, shoulders, elbows, hips, knees, and feet. These key points are accompanied by the bounding box coordinates for the detected person.

The number of key points is configurable and not limited to 17. Depending on the system requirements, the configuration can be adjusted to output fewer or additional points to suit the specific application or analysis needs.

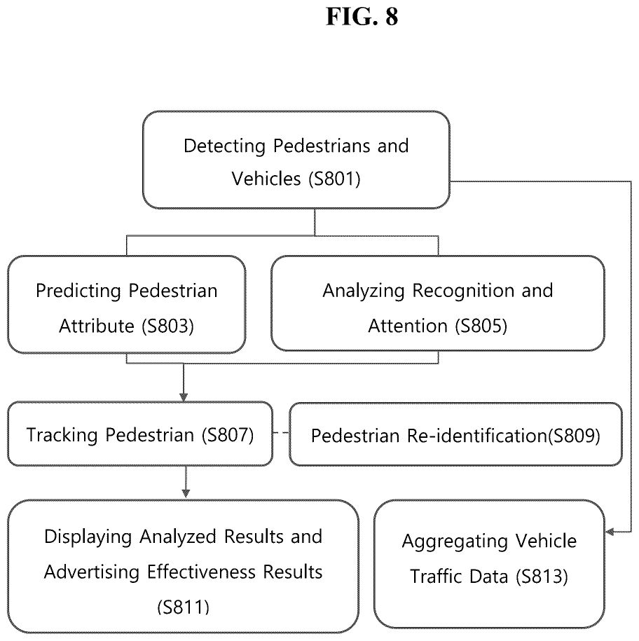

FIG. 8 depicts another embodiment of the method for analyzing advertising effectiveness. According to FIG. 8, the process begins with the vision sensor detecting pedestrians and vehicles in the vicinity of the advertising medium (Step S801). FIG. 8 illustrates a sample screen where the vision sensor identifies pedestrians and vehicles within its field of view.

The object detection process plays a role in ensuring comprehensive coverage so that no individuals or vehicles are missed in any video frame or image. Incorrect detections, such as bounding boxes with erroneous coordinates or misidentified objects, can adversely impact accuracy. To address these challenges, the disclosure employs a combination of object detection and body pose estimation technologies, enhanced by a detection ensemble technique, to improve detection precision.

The detection ensemble technique refines object boundaries by combining the bounding box results from both detection methods. It calculates intersections and unions of bounding box coordinates to generate more accurate outlines for detected objects. This approach ensures that individuals' outlines are captured with greater precision. To further enhance detection accuracy, the system can upscale the resolution of input images and optimize detection thresholds for each technology. This ensures that objects at greater distances are not overlooked. Additionally, using high-resolution cameras and high-performance GPUs to capture real-time video (e.g., at 30 frames per second or higher) significantly improves the accuracy and reliability of object detection.

The system predicts pedestrian attributes (Step S803) and analyzes advertising recognition and attention (Step S805). Following object detection, the system utilizes image analysis AI models, such as Vision Transformer (ViT), to predict various attributes of pedestrians, including exposure time, gender, age, and movement direction. Exposure time refers to the duration during which a pedestrian is exposed to the advertisement. Gender and age are inferred from the pedestrian's appearance and clothing features, analyzed through deep learning models trained for this purpose. The system determines whether pedestrians recognize or pay attention to the advertisement using Head Pose Estimation technology. This technology predicts the 3D orientation vector of a pedestrian's head from 2D upper-body images. To estimate the likelihood of ad recognition, the system reconstructs head orientation within a 3D coordinate system. A proprietary algorithm is then used to differentiate between simple recognition and active attention. To further improve accuracy, the system calibrates the positions of the advertising medium and the camera, establishing a world coordinate system. By comparing the pedestrian's head orientation within this system, the system precisely determines whether the pedestrian is looking at the advertisement.

The system continuously detects and tracks pedestrians in real time (Steps S807-S809). If tracking is interrupted, pedestrian re-identification (ReID) technology ensures seamless tracking by matching objects across frames. Object Tracking assigns a consistent ID to each detected pedestrian across consecutive frames, preventing misidentification and ensuring continuity. ReID Matching compares bounding boxes from different frames, identifying the same individual based on overlapping areas. This maintains tracking accuracy when interruptions occur. Object tracking is critical for analyzing videos or multiple image frames. Without it, the system may incorrectly identify the same person in different frames as separate individuals, leading to inaccuracies. By assigning unique IDs, the system accumulates attribute data (e.g., gender, age) and behavioral data (e.g., viewing time, attention time, movement speed, and direction) for each tracked individual. To enhance tracking accuracy, the system applies Prediction Accumulation, a technique that aggregates tracking data over time. Using arithmetic logic, conditional logic, or majority-vote logic, Prediction Accumulation refines predictions and ensures consistent results.

The system provides a user-friendly dashboard on terminal devices, displaying advertising analysis data and effectiveness measurement results (Step S811). Data is visualized using charts, graphs, and other graphical representations to enhance readability and aid decision-making. Through the dashboard, users can access detailed pedestrian attributes such as exposure time, gender, and age, alongside audience metrics for actual and potential viewers. This data empowers advertisers to analyze performance and optimize their advertising strategies effectively.

In addition to pedestrian tracking, the system aggregates vehicle traffic data collected by sensors near the advertising medium (Step S813). This includes data on vehicle types, traffic volume, movement speed, and direction. The vehicle traffic data is integrated with pedestrian and advertising effectiveness data to provide a comprehensive analysis of audience flow in the vicinity of the advertising medium.

By combining advanced technologies, including object detection, body pose estimation, head pose estimation, object tracking, and ReID Matching, the system performs real-time analysis of pedestrian and vehicle attributes. It tracks pedestrian exposure, recognition, and attention to advertisements, calculates demographic data, and presents visualized reports through a user dashboard. The integration of vehicle traffic data further enhances the system's ability to measure advertising effectiveness across diverse environments, delivering advertisers accurate and actionable insights for campaign optimization.

The disclosure leverages machine learning and deep learning technologies to analyze and measure advertising effectiveness. Data collected from sensors, such as cameras, is processed using AI image recognition algorithms, which convert the information into machine-learnable features. These features are analyzed by a server or computing device using advanced AI models to generate advertising effectiveness measurements.

Traditionally, face-based gender and age classification models have been widely used; however, their accuracy diminishes significantly when analyzing individuals located more than 5 meters away. This limitation arises because pixel-level facial information becomes too small to yield reliable results. As most outdoor advertising media are viewed from distances exceeding 5 meters, the need for accurate analysis at greater distances is critical.

To overcome this challenge, the disclosure employs a model that learns features from the entire body instead of relying solely on facial features. By analyzing the full body, the model utilizes up to 10 times more information compared to face-based models, greatly improving accuracy for individuals observed at distances greater than 5 meters. Additionally, the model can accurately classify gender and age even when individuals are viewed from behind.

The disclosure further enhances the AI image analysis model by segmenting the human body into three sections—upper body, lower body, and feet—and learning the distinct features of each section to improve inference performance. Transformer-based models, such as Vision Transformer (ViT), are employed to achieve state-of-the-art performance in computer vision tasks. Vision Transformer (ViT) is a highly scalable computer vision technology that performs image recognition tasks on large datasets, making it particularly suitable for analyzing advertising effectiveness across diverse environments. Unlike traditional models that primarily focus on facial features, the full-body model utilized in the disclosure is capable of handling images captured from diverse perspectives, including back views. This robustness makes the system ideal for outdoor advertising scenarios where individuals often view advertisements from angles that obscure their faces.

Many existing full-body models are trained on global datasets, which often have lower accuracy for specific demographics, such as East Asians and particularly Korean individuals, due to underrepresentation in training data. To address this limitation, the disclosure incorporates region-specific and country-specific datasets. Approximately one million labeled images of East Asians and Koreans are included in the training data, significantly improving classification accuracy for these demographics from 85% to 95%, a notable enhancement compared to other models.

Efficient real-time analysis is crucial, especially when the computing device operates in an on-device configuration, such as being embedded within the advertising medium. The analysis of full-body features to classify gender and age is computationally intensive, necessitating techniques to reduce processing time without sacrificing accuracy. The disclosure applies quantization techniques to lower computational complexity by more than 50%, enabling faster analysis suitable for real-time applications. Quantization is a method for reducing the computational complexity of AI models. It achieves three primary objectives: reducing computation time to accelerate processing, saving storage space to optimize resource utilization, and lowering power consumption to enhance efficiency for low-power devices. By applying quantization, the system maintains high efficiency while preserving the accuracy of AI models. This capability enables real-time analysis on low-power devices, such as smartphones or embedded systems within the advertising medium, where computational resources are constrained.

To balance computational efficiency and analytical accuracy, the disclosure employs a combination of model quantization, parallel processing across analysis models, and process flow optimization. These measures collectively reduce processing time by over 50%. For instance, when analyzing an image of a large space containing at least 50 individuals, the system completes all processing steps—detection, gender and age classification, attention analysis, tracking, and re-identification—in just 78.9 milliseconds. This performance enables the system to analyze 12 images per second, making it over three times faster than traditional methods.

| | | Gender | | Tracking & | |
|---|---|---|---|---|---|
| | | & Age | Attention | Re- | |
| | Detection | Classification | Analysis | identification | Total |
| Processing | 10.2 | 12.5 | 23.6 | 32.5 | 78.9 ms |
| Time (ms) | | | | | |

The disclosure introduces significant advancements in advertising effectiveness analysis, offering the following key advantage: Enhanced Accuracy at Greater Distances (i.e., full-body feature-based models improve analysis accuracy for individuals located more than 5 meters away, addressing the limitations of face-based models); Region-Specific Training (i.e., incorporation of one million labeled images of East Asians and Koreans increases demographic-specific accuracy to 95%, significantly improving performance compared to conventional models); Computational Efficiency (i.e., quantization techniques reduce computational complexity while preserving model accuracy, enabling faster and more efficient processing); Real-Time Processing (i.e., the system processes 12 images per second, achieving analysis speeds that are three times faster than traditional methods); On-Device Deployment (i.e., optimized models enable efficient analysis on embedded systems with limited computational resources, making the system versatile for various deployment scenarios). These innovations enable the system to provide accurate, efficient, and real-time advertising effectiveness measurements, making it ideal for use in diverse environments, including large outdoor spaces with high pedestrian and vehicle traffic volumes.

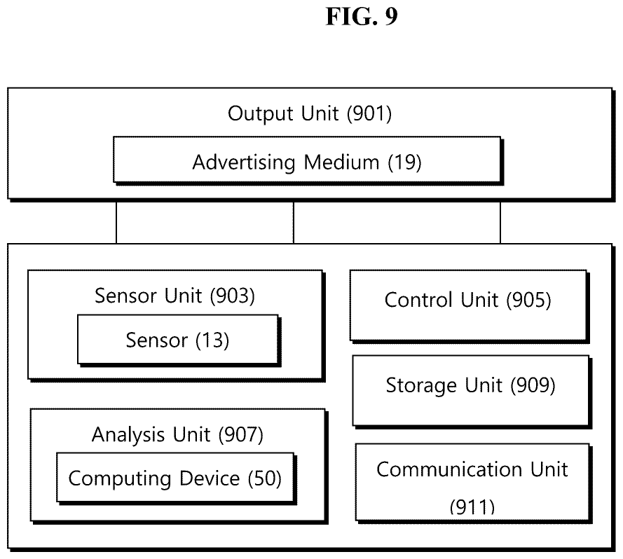

FIG. 9 illustrates the configuration of an advertising effectiveness analysis device according to an embodiment of the disclosure. The device comprises an output unit (901), a sensor unit (903), a control unit (905), an analysis unit (907), a storage unit (909), and a communication unit (911).

The output unit (901) includes the advertising medium (19), such as a display device, which outputs advertisements in the form of images, videos, or other information. The sensor unit (903) consists of various sensors (13), including vision sensors and environmental sensors, which collect surrounding information near the advertising medium. This information may include the presence of pedestrians, vehicles, and weather conditions.

The control unit (905) manages the overall operation of the device by coordinating the functions of the output unit, sensor unit, analysis unit, storage unit, and communication unit. It ensures that all components operate efficiently to measure and analyze the effectiveness of advertisements.

The analysis unit (907) includes the computing device (50), which processes data collected by the sensors and performs analyses to measure advertising effectiveness. This unit applies AI models to evaluate metrics such as exposure count, viewership count, attention count, gender and age distribution, movement paths, and dwell times. Additionally, the analysis unit employs object detection, body pose estimation, object tracking, and re-identification technologies to analyze individuals and vehicles in real time.

The storage unit (909) stores various types of data, including information collected by the sensors, analyzed data, advertising effectiveness results, and advertisement display information necessary for operating the advertising medium. This data can be utilized for further analysis, report generation, and performance evaluation of the advertising medium.

The communication unit (911) manages data transmission and network connectivity among different components, such as sensors, terminal devices (15), advertising media (19), mobile vehicles (20), and servers (30). Supporting both wired and wireless communication methods, the communication unit ensures seamless data flow within the system.

The components of the advertising effectiveness analysis device (901-911) may be excluded, relocated, or modified depending on the operational method and environmental conditions of the advertising medium. For example, certain components may be installed separately from the advertising medium or integrated into other devices to enhance system performance.

Although the disclosure has been described through specific embodiments and illustrations, it should be understood that various modifications, variations, applications, and combinations may be implemented without departing from the core spirit and scope of the disclosure. For example, the described technologies can be performed in a different order, or the systems, structures, devices, and circuits can be combined or configured in alternative ways. Components may also be replaced or substituted with equivalent elements to achieve the same results. Accordingly, any modifications, variations, or equivalent elements related to the disclosure should be considered within the scope of the claims provided below. The disclosure is not limited to the specific embodiments described in the specification but should be interpreted in light of the claims and their equivalents.

What is claimed is:

1. An apparatus for measuring advertising effectiveness of an advertising medium, the apparatus comprising:
at least one processor; and
at least one memory storing one or more programs,
wherein the at least one processor connected to the memory is configured, by executing the one or more programs, to:
capture, by a vision sensor, images or videos of individuals within a visibility range of the advertising medium;
detect one or more individuals in the images or videos and generate individual bounding boxes;
apply a full-body model to segment a human body of each individual into an upper-body section, a lower-body section, and a feet section and extract features from each section;
determine, based on the extracted features, at least one demographic attribute of each individual, including at least one of gender or age, even when a face of the individual is not visible or the individual is observed from a back view;
perform object tracking to assign a unique object ID to each individual and maintain the object ID across consecutive frames;
perform ReID matching to compare the individual bounding boxes across frames and maintain continuity of the object ID when an individual changes position or disappears;
generate, for each object ID, frame-level predictions including at least one of a gender prediction, an age prediction, an exposure state prediction, a viewing state prediction, or an attention state prediction with respect to an advertising medium;
apply prediction accumulation that aggregates the frame-level predictions associated with the object ID; and
determine, for each object ID, final attribute values including at least one of a final gender, a final age group, a final exposure state, a final viewing state, or a final attention state based on results of the prediction accumulation, thereby generating advertising effectiveness measurement for the advertising medium based on the final attribute values.

2. The apparatus of claim 1, wherein the full-body model is trained using training data including region-specific and country-specific datasets comprising images of at least one of East Asian or Korean individuals, and is configured to learn region-specific body shape characteristics to improve accuracy of gender and age classification when viewing the individuals at distances and in back-view images.

3. The apparatus of claim 1, wherein the full-body model learns the features of each section to enhance inference performance, and wherein the full-body model includes a transformer-based architecture including a Vision Transformer (VIT).

4. The apparatus of claim 1, wherein the prediction accumulation applies at least one of arithmetic logic, conditional logic, and majority-vote logic to the frame-level predictions associated with each object ID to produce the final attribute values.

5. The apparatus of claim 1, wherein the at least one processor is configured to:
execute object detection to detect both individuals and vehicles and output bounding box coordinates for each detected object;
execute body pose estimation to output coordinates of key body points of the individuals;
execute head pose estimation to determine head orientation and gaze direction of the individuals; and
employ a detection ensemble technique that combines results of object detection and body pose estimation by at least calculating intersections and unions of bounding box coordinates to refine outlines of the individuals.

6. The apparatus of claim 5, wherein the detection ensemble technique further includes upscaling a resolution of input images and optimizing detection thresholds for the object detection and the body pose estimation so that individuals at distances are not overlooked, and optionally incorporating results of the head pose estimation into the refinement of the individual bounding boxes.

7. The apparatus of claim 1, wherein the at least one processor is further configured to:
count vehicles;
classify the vehicles into at least one of a car, a bus, a truck, or a motorcycle;
apply weighting factors corresponding to an average number of individuals for each vehicle;
estimate a potential audience size of individuals inside the vehicles by applying the weighting factors to the counted vehicles; and
combine actual audience data with the potential audience size to generate aggregated audience metrics for the advertising medium.

8. The apparatus of claim 7, wherein the weighting factors are dynamically adjusted based on at least one context parameter selected from a group consisting of a time period, a day of week, a location of the advertising medium, or a weather condition, such that the potential audience size reflects an expected number of individuals under the context parameter.

9. The apparatus of claim 1, wherein the at least one processor is configured to collected data, detect an object, analyze, or optimize a process, and wherein the process optimization causes at least one of object detection, body pose estimation, head pose estimation, object tracking, ReID matching, or prediction accumulation to be executed in parallel.

10. The apparatus of claim 9, wherein the apparatus is configured to allocate computing resources and schedule execution of the object detection, body pose estimation, head pose estimation, object tracking, ReID matching, and prediction accumulation such that, for a scene including at least a predetermined number of individuals, the apparatus performs, for each frame of the scene, detection, gender and age classification, viewing and attention analysis, tracking, and prediction accumulation in real time.

11. A method for measuring advertising effectiveness of an advertising medium, the method comprising:
at an apparatus with at least one processor and memory:
capturing, by a vision sensor, images or videos of individuals within a visibility range of the advertising medium;
detecting one or more individuals in the images or videos and generating individual bounding boxes;
applying a full-body model to segment a human body of each individual into an upper-body section, a lower-body section, and a feet section and extract features from each section;
determining, based on the extracted features, at least one demographic attribute of each individual, including at least one of gender or age, even when a face of the individual is not visible or the individual is observed from a back view;
performing object tracking to assign and maintain a unique object ID for each individual across consecutive frames;
performing ReID matching to compare the individual bounding boxes across frames and maintain continuity of the object ID when an individual moves or disappears;
generating, for each object ID, frame-level predictions including at least one of a gender prediction, an age prediction, an exposure state prediction, a viewing state prediction, and an attention state prediction with respect to the advertising medium;
performing prediction accumulation by aggregating the frame-level predictions associated with the object ID to refine the frame-level predictions;
determining, for each object ID, final attribute values including at least one of a final gender, a final age group, a final exposure state, a final viewing state, and a final attention state based on results of the prediction accumulation; and
generating advertising effectiveness measurement for the advertising medium based on the final attribute values.

12. The method of claim 11, wherein applying the full-body model comprises using a model trained on region-specific and country-specific datasets including images of at least one of East Asian or Korean individuals, and the full-body model is configured to classify gender and age for the individuals located at distance and for individuals observed from back-view images.

13. The method of claim 11, wherein applying the full-body model comprises segmenting the human body into the upper-body section, the lower-body section, and the feet section and learning features of each section using a transformer-based architecture including a Vision Transformer (ViT).

14. The method of claim 11, wherein performing the prediction accumulation comprises applying at least one of arithmetic logic, conditional logic, and majority-vote logic to the frame-level predictions associated with each object ID to determine the final attribute values.

15. The method of claim 11, further comprising:
detecting vehicles within the visibility range of the advertising medium and classifying the vehicles;
applying weighting factors corresponding to an average number of individuals for each vehicle;
estimating a potential audience size representing a number of individuals inside the vehicles by applying the weighting factors to the classified vehicles; and
combining actual audience data of individuals with the potential audience size.

16. The method of claim 15, wherein the weighting factors are adjusted based on at least one parameter selected from a group consisting of a time period, a day of week, a location of the advertising medium, and a weather condition.

17. The method of claim 11, further comprises executing, in parallel, at least object detection, body pose estimation, head pose estimation, object tracking, ReID matching, and the prediction accumulation, and scheduling execution of these processes such that, for a scene including at least a predetermined number of individuals, the object detection, gender and age classification, viewing and attention analysis, tracking, and the prediction accumulation for each frame are completed.
